(19) United States
(12) Patent Application Publication
(10) Pub. No.: US 2016/0150133 A1
(43) Pub. Date: May 26, 2016

(54) ELECTRONIC DEVICE MODULE HAVING AN IMAGING UNIT

(71) Applicant: KABUSHIKI KAISHA TOSHIBA, Tokyo (JP)

(72) Inventors: Daigo SUZUKI, Kawasaki Kanagawa (JP); Akihiko HAPPOYA, Ome Tokyo (JP); Jun OOTSUBO, Yokohama Kanagawa (JP); Fongru LIN, Yokohama Kanagawa (JP)

(21) Appl. No.: 14/822,883

(22) Filed: Aug. 10, 2015

(30) Foreign Application Priority Data
Nov. 26, 2014 (JP) 2014-238881

(51) Int. Cl. H04N 5/225; H04N 5/232

(52) U.S. Cl. CPC H04N 5/2252; H04N 5/2254; H04N 5/2256; H04N 5/2257; H04N 5/23293

(57) ABSTRACT

An electronic device module includes a substrate, an imaging unit disposed on the substrate and electrically connected thereto, a resin member disposed on the substrate and covering an peripheral region of the imaging unit, a lens unit disposed above the imaging unit, and a frame having a portion that is disposed on a top surface of the resin member and supports the lens unit.

### CROSS-REFERENCE TO RELATED APPLICATION

This application is based upon and claims the benefit of priority from Japanese Patent Application No. 2014-238881, filed Nov. 26, 2014, the entire contents of which are incorporated herein by reference.

### FIELD

Embodiments described herein relate generally to an electronic device module having an imaging unit.

### BACKGROUND

Recently, an electronic device module, such as a camera module, is used in various electronic devices. One type of the electronic device module includes an imaging unit disposed on a rigid substrate.

### DESCRIPTION OF THE DRAWINGS

FIG. 1 is a perspective view of an electronic device including an electronic device module according to a first embodiment.

FIG. 2 is a perspective view of the electronic device module (camera module) illustrated in FIG. 1.

FIG. 3 is a cross-sectional view of the electronic device module illustrated in FIG. 2.

FIG. 4 is a cross-sectional view of the electronic device taken along line F4-F4 in FIG. 3.

FIG. 5 is a cross-sectional view of the electronic device taken along line F5-F5 in FIG. 3.

FIG. 6 illustrates an example of a manufacturing method of the electronic device module illustrated in FIG. 2.

FIG. 7 is a cross-sectional view of an electronic device illustrating a modification example.

FIG. 8 is a cross-sectional view of an electronic device module according to a second embodiment.

FIG. 9 is a cross-sectional view of an electronic device module according to a third embodiment.

### DETAILED DESCRIPTION

One or more embodiments are directed to provide an electronic device module which is thinner while maintaining rigidity.

In general, according to an embodiment, an electronic device module includes a substrate, an imaging unit disposed on the substrate and electrically connected thereto, a resin member disposed on the substrate and covering an peripheral region of the imaging unit, a lens unit disposed above the imaging unit, and a frame having a portion that is disposed on a top surface of the resin member and supports the lens unit.

Hereinafter, embodiments will be described with reference to the drawings.

In the description, multiple expression examples are used for several elements. These expression examples are merely used as an example, and may be expressed by other expressions. In addition, elements to which the multiple expression examples are not used may be expressed by the other expressions.

The drawings are schematic drawings. A relationship between a thickness and planar dimensions or a thickness ratio between respective layers may be different from that used in practice. In addition, the respective drawings may partially include dimensional relationships or dimensional ratios which are different from each other.

### First Embodiment

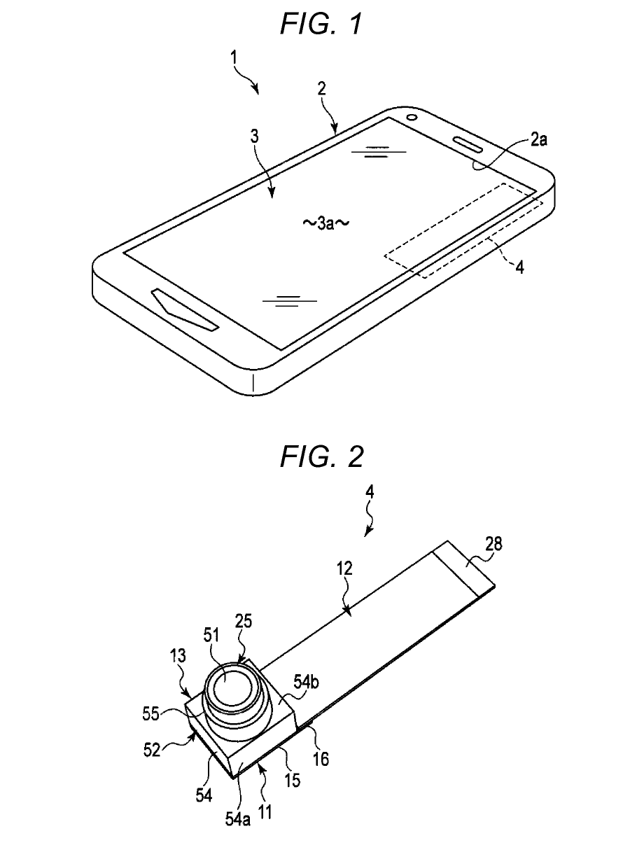

FIG. 1 illustrates an electronic device 1 according to a first embodiment. For example, the electronic device 1 is a mobile phone (smart phone), but is not limited thereto. For example, the electronic device 1 may be the other electronic devices such as portable computers, smart devices (for example, tablet terminals), image display devices (for example, television receivers), and game machines.

As illustrated in FIG. 1, the electronic device 1 includes a housing 2, and a display device 3 and a camera module 4 which are respectively accommodated in the housing 2. The housing 2 has an opening 2a through which a display screen 3a of the display device 3 is exposed. For example, the opening 2a is covered with a transparent protection panel (for example, glass panel or plastic panel).

FIG. 2 illustrates the camera module 4 according to the embodiment described herein. The camera module 4 is an example of an “electronic module” and a “semiconductor module.” The camera module 4 includes a flexible printed substrate 11 (flexible planar substrate), a flexible printed wiring board 12, and a camera unit 13 (camera component, electronic component, and functional component).

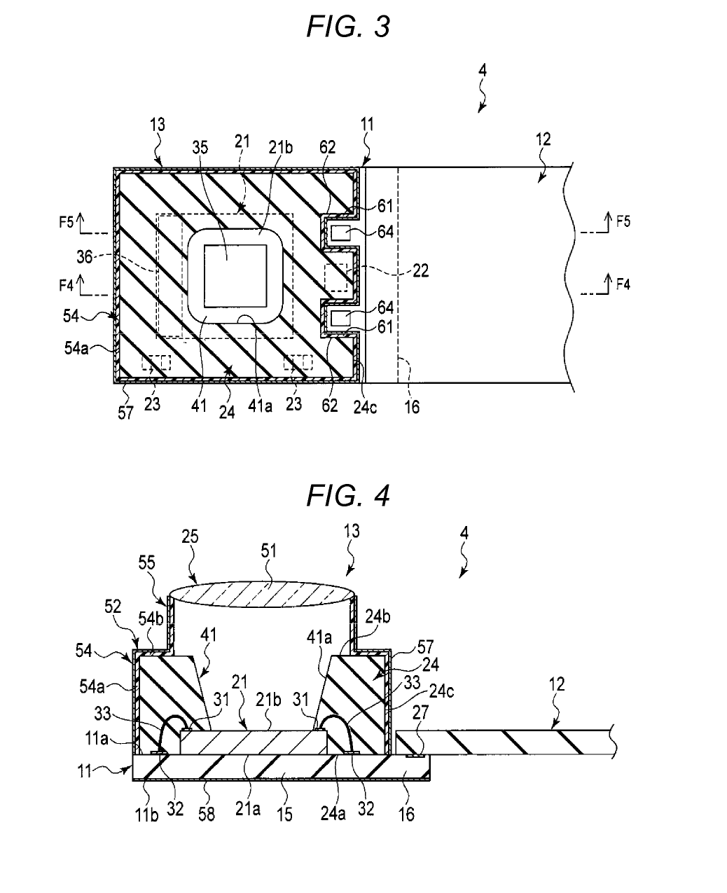

FIGS. 3 to 5 illustrate details of the camera module 4. As illustrated in FIGS. 3 to 5, the flexible printed wiring board 11 (hereinafter, referred to as a flexible substrate 11) is an example of an “ultrathin planar substrate.” The flexible substrate 11 has a flexible base film formed of polyimide, a wiring pattern formed on the base film, and a cover lay film covering the wiring pattern, and the flexible substrate 11 has flexibility. The cover lay film may be omitted therefrom.

For example, the flexible substrate 11 is a so-called two-layer board (double-sided board), and may be a single-layer board, a three-layer board, or a four-layer board instead of the two-layer board. In addition, the flexible substrate 11 may be a rigid wiring board. For example, the thickness of the flexible substrate 11 is smaller than the thickness of an imaging device 21 (to be described below). Without being limited to the above-described thickness, the thickness of the flexible substrate 11 may be equal to the thickness of the imaging device 21, or may be greater than the thickness of the imaging device 21.

As illustrated in FIGS. 3 to 5, the flexible substrate 11 has a first surface 11a and a second surface 11b, which is located on a side opposite to the first surface 11a. In addition, the flexible substrate 11 has a first region 15 and a second region 16. The first region 15 (region having component mounted thereon) is a region in which the imaging device 21 (to be described below), a controller 22, an electronic component 23, a molded resin body 24, and a lens unit 25 are disposed (that is, region on which the camera unit 13 is mounted, region overlapping the camera unit 13). The second region 16 (region having no component mounted thereon, extension region, and externally connected region) is a region which is adjacent to the first region 15 and in which the imaging device 21, the controller 22, the electronic component 23, the molded resin body 24, and the lens unit 25 are not disposed. A surface of the second region 16 (for example, first surface 11a) has a terminal 27 which is exposed outward on the surface of the flexible substrate 11.

The flexible printed wiring board 12 (hereinafter, referred to as a flexible substrate 12) overlaps the second region 16 of the flexible substrate 11, and is electrically connected to the terminal 27. For example, the flexible substrate 12 is connected to the terminal 27 of the flexible substrate 11 via an anisotropic conductive film (ACF).

An end portion of the flexible substrate 12 has an interface 28 which may be connected to an external connector (FIG. 2). The flexible substrate 12 has a flexible base film formed of polyimide, a wiring pattern formed on the base film, and a cover lay film covering the wiring pattern, and the flexible substrate 12 has flexibility.

Next, the camera unit 13 will be described. As illustrated in FIGS. 3 to 5, the camera unit 13 includes the imaging device 21, the controller 22, the multiple electronic components 23, the molded resin body 24, and the lens unit 25. The imaging device 21 is an example of a “light receiving element array” and an “optical element,” and is a complementary MOS (CMOS) sensor, for example. For example, the imaging device 21 is a rectangular semiconductor chip. The imaging device 21 is disposed in the first region 15 of the flexible substrate 11. The imaging device 21 is fixed to the first surface 11a of the flexible substrate 11 with an adhesive (adhesive agent or adhesive sheet).

As illustrated in FIG. 4, the imaging device 21 has a first surface 21a and a second surface 21b. The first surface 21a faces the flexible substrate 11. The second surface 21b is located on a side opposite to the first surface 21a, and extends in a direction substantially parallel with a direction in which the first surface 21a extends. Multiple pads 31 for wire bonding are disposed in a peripheral end portion of the second surface 21b of the imaging device 21.

Multiple pads 32 are disposed on the first surface 11a of the flexible substrate 11. The camera unit 13 includes multiple bonding wires 33 extending between the imaging device 21 and a surface (first surface 11a) of the first region 15. The bonding wire 33 extends between the pad 31 of the imaging device 21 and the pad 32 of the flexible substrate 11, and electrically connects the imaging device 21 and the flexible substrate 11 to each other.

As illustrated in FIG. 3, the second surface 21b of the imaging device 21 has a pixel region 35 (imaging unit, imaging region, light receiving unit, and light receiving region) and a logic circuit 36. The pixel region 35 is a region where pixels are arrayed side by side, and is disposed apart from a side of the imaging device 21 along which the logic circuit 36 is located. In contrast, the logic circuit 36 is disposed in one end portion of the imaging device 21. Heat generation from the logic circuit 36 is greater than that from the pixel region 35.

As illustrated in FIG. 3, the controller 22 and the multiple electronic components 23 are disposed on the first surface 11a of the first region 15 of the flexible substrate 11. The controller 22 and the multiple electronic components 23 are separately disposed around the imaging device 21. The controller 22 is an example of an “IC component,” a “chip component,” and an “electronic component.”

The controller 22 is electrically connected to the imaging device 21 via the wiring pattern and the bonding wire 33 of the flexible substrate 11, and controls the imaging device 21. The electronic component 23 is a passive element, for example, and is a capacitor or resistance, for example. The electronic component 23 is not limited to the above-described examples.

Next, the molded resin body 24 will be described. As illustrated in FIG. 4, the molded resin body 24 is disposed on the first surface 11a of the first region 15 of the flexible substrate 11. The molded resin body 24 has insulating property. The molded resin body 24 covers the peripheral end portion of the imaging device 21, and seals the multiple bonding wires 33.

The molded resin body 24 is disposed so as to avoid the pixel region 35. In other words, the molded resin body 24 has an opening 41 through which the pixel region 35 is exposed. A size of the opening 41 is larger than a size of the pixel region 35. For example, an inner surface 41a of the opening 41 is formed into an inverted cone shape (mortar shape) of which inner diameter increases as the shape is apart from the imaging device 21.

For example, the molded resin body 24 is formed of a resin having a color on which light is less likely to be reflected, and is formed of a black resin, for example. The molded resin body 24 may be formed of resin of another color, and treatment for suppressing the light reflection (for example, black color painting) may be performed on the inner surface 41a of the opening 41.

Light incident on the imaging device 21 is condensed by a lens 51 (to be described below). Accordingly, the light is not likely to be incident on the inner surface 41a of the opening 41. However, according to the above-described configuration, even when the light is incident on the inner surface 41a of the opening 41, the light is prevented from being reflected by the inner surface 41a of the opening 41 and incident on the imaging device 21.

In contrast, as illustrated in FIG. 3, the molded resin body 24 covers the logic circuit 36 of the imaging device 21. That is, the molded resin body 24 is in contact with the logic circuit 36 on the second surface 21b of the imaging device 21.

In the embodiment described herein, the center of imaging device 21 is disposed apart from the center of the opening 41. That is, the center of the imaging device 21 is disposed apart from the center of the opening 41 in a direction where the logic circuit 36 is apart from the opening 41. In this manner, the entire region of the logic circuit 36 can be securely covered with the molded resin body 24.

The molded resin body 24 is thermally connected to the logic circuit 36. Furthermore, the molded resin body 24 covers the controller 22 and the multiple electronic components 23. The molded resin body 24 is also thermally connected to the controller 22 and the multiple electronic components 23. In this manner, the molded resin body 24 may receive a portion of heat generated from the imaging device 21, the controller 22, and the electronic components 23.

As illustrated in FIG. 3, for example, an outer shape of the molded resin body 24 is formed in a rectangular shape and extends along an outer shape of the flexible substrate 11. As illustrated in FIG. 4, the molded resin body 24 has a first surface 24a, a second surface 24b, and a side surface 24c (third surface).

The first surface 24a faces the flexible substrate 11, and closely adheres to the first surface 11a of the flexible substrate 11, for example. The second surface 24b is located on a side opposite to the first surface 24a, and extends in a direction substantially parallel with a direction in which the first surface 24a extends. That is, the second surface 24b extends in a direction substantially parallel with a direction in which the first surface 11a of the flexible substrate 11 extends. The side surface 24c extends between an edge of the first surface 24a and an edge of the second surface 24b. For example, the side surface 24c extends in a direction substantially perpendicular to the first surface 11a of the flexible substrate 11 (that is, thickness direction of the flexible substrate 11).

Next, the lens unit 25 will be described. As illustrated in FIG. 4, the lens unit 25 includes a lens 51 (lens portion) and a frame 52. For example, the lens 51 includes multiple lens elements overlapping each other, and has a focus function by moving the lens elements. The lens 51 faces the imaging device 21 in the thickness direction of the flexible substrate 11.

The frame 52 includes a first portion 54 and a second portion 55. The first portion 54 extends along an outer surface of the molded resin body 24. That is, the first portion 54 has a first wall 54a (side wall) extending along the side surface 24c of the molded resin body 24, and a second wall 54b (flat wall, ceiling wall) extending along the second surface 24b of the molded resin body 24. The first portion 54 is covered with the molded resin body 24, and covers the molded resin body 24.

For example, the frame 52 may be fixed to the flexible substrate 11 by the first portion 54 being attached to the molded resin body 24. Alternatively, the frame 52 may be fixed to the flexible substrate 11 by the first portion 54 being directly attached to the flexible substrate 11. In this case, some gap no gap may be present between the inner surface of the frame 52 and the molded resin body 24.

For example, the second portion 55 of the frame 52 is slightly smaller than the first portion 54. For example, the second portion 55 is formed into a cylindrical shape and extends from an outer periphery of the lens 51. The second portion 55 of the frame 52 is disposed on the second wall 54b of the first portion 54, and supports the lens 51 at a position which is apart from the imaging device 21 with a predetermined distance therebetween.

As illustrated in FIGS. 3 and 4, for example, a conductive shield layer 57 is disposed on the overall surface of the first portion 54 and the second portion 55 of the frame 52. For example, the shield layer 57 is formed by plating, sputtering, or conductive painting. The shield layer 57 may be disposed on an outer surface of the frame 52, or may be disposed on an inner surface of the frame 52. The shield layer 57 is electrically connected to the ground of the flexible substrate 11, thereby being at a ground potential. The shield layer 57 is a conductive layer for dealing with electromagnetic interference (EMI). The shield layer 57 may not be disposed on the overall surface of the frame 52. A region having no shield layer 57 may be partially formed in the frame 52 for various reasons.

As illustrated in FIG. 4, the second surface 11b of the flexible substrate 11 includes a ground layer 58. For example, the ground layer 58 is formed on a substantially overall surface of the second surface 11b of the flexible substrate 11. The ground layer 58 is electrically connected to the ground of the flexible substrate 11, thereby being at the ground potential. In this manner, the imaging device 21, the controller 22, and the multiple electronic components 23 are surrounded by (covered with) the shield layer 57 or the ground layer 58 in substantially all regions.

Next, an electrical connection structure between the lens 51 and the flexible substrate 11 will be described.

As illustrated in FIG. 3, the first portion 54 of the frame 52 has multiple (for example, a pair) concave portions 61 recessed inward from the first wall 54a (side surface). The concave portion 61 is recessed toward the imaging device 21. For example, the concave portion 61 is disposed to range substantially overall height of the first portion 54 in the thickness direction of the flexible substrate 11.

The surface of the molded resin body 24 has a recess 62 corresponding to the concave portion 61 of the frame 52. That is, the recess 62 of the molded resin body 24 is recessed inward from the molded resin body 24 so as to avoid the concave portion 61 of the frame 52 which protrudes toward the molded resin body 24. For example, the recess 62 of the molded resin body 24 is disposed to range substantially overall height of the molded resin body 24 along the concave portion 61 of the frame 52. For example, the concave portion 61 of the frame 52 may be attached to the recess 62 of the molded resin body 24.

As illustrated in FIG. 3, the surface (first surface 11a) of the flexible substrate 11 has multiple (for example, a pair of) electrodes 64 (pads, terminals). For example, the multiple electrodes 64 are electrodes for controlling the lens 51 (for example, controlling the focus function), and includes a positive electrode and a negative electrode. The multiple electrodes 64 are separately located in the multiple concave portions 61. At least a part of the respective electrodes 64 is disposed inside the concave portion 61. In the embodiment described herein, half or more (for example, all) of the respective electrodes 64 are located inside the concave portion 61. The electrodes 64 may be partially located outside the concave portion 61.

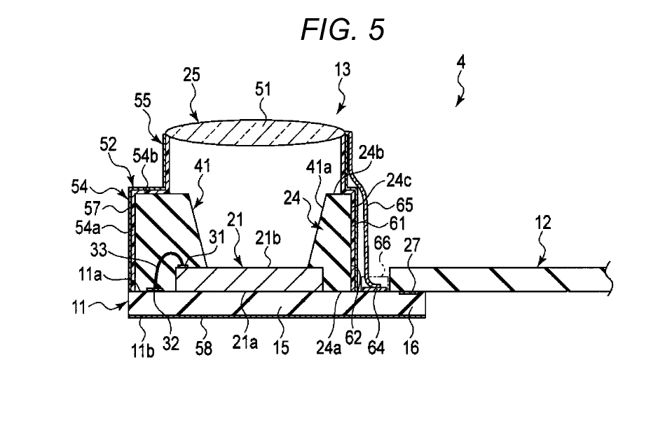

As illustrated in FIG. 5, the lens unit 25 includes a wiring unit 65. For example, the wiring unit 65 is disposed outside the frame 52. An example of the wiring unit 65 includes the flexible printed substrate connected to the lens 51. That is, an example of the wiring unit 65 includes the flexible printed wiring board (flexible wiring board). For example, the wiring unit 65 extends from the lens 51 (or circuit for controlling the lens 51) and along the outer surface of the frame 52.

The wiring unit 65 extends between the lens 51 and the electrode 64 of the flexible substrate 11 outside the frame 52, and is electrically connected to the electrode 64. For example, the wiring unit 65 is connected to the electrode 64 by soldering. In this manner, the lens 51 is electrically connected to the flexible substrate 11.

Alternatively, the wiring unit 65 and the electrode 64 may be electrically connected to each other by disposing a connector 66 (socket) connected to the electrode 64 on the surface (first surface 11a) of the flexible substrate 11, and by inserting an end portion of the wiring unit 65 into the connector 66 (refer to a two-dot chain line in FIG. 5).

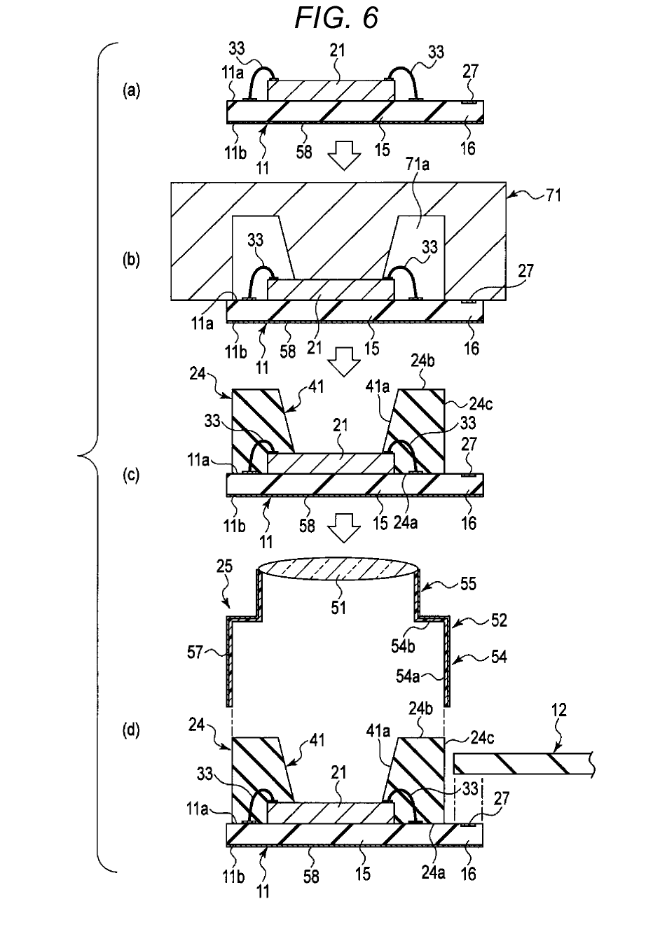

Next, an example of a manufacturing method of the camera module 4 will be described. FIG. 6 illustrates an example of a manufacturing method of the camera module 4. In the manufacturing method, the flexible substrate 11 is first prepared, and the controller 22 and the electronic component 23 are mounted on the first surface 11a of the flexible substrate 11. Then, the imaging device 21 is attached to the first surface 11a of the flexible substrate 11. The imaging device 21 is electrically connected to the flexible substrate 11 through the bonding wire 33 (refer to (a) of FIG. 6).

Then, a mold 71 is attached to the first surface 11a of the flexible substrate 11 (refer to (b) of FIG. 6). The mold 71 has an internal space 71a corresponding to the outer shape of the molded resin body 24. A material for the molded resin body 24 is injected into the internal space 71a, and is cured, thereby forming the molded resin body 24 (refer to (c) of FIG. 6).

Then, the molded resin body 24 is covered with the lens unit 25, and the wiring unit 65 of the lens unit 25 is electrically connected to the electrode 64. In addition, the flexible substrate 12 is connected to the flexible substrate 11 (refer to (d) of FIG. 6). In this manner, the camera module 4 is manufactured.

According to this configuration, it is possible to provide the camera module 4 which is thinner while maintaining rigidity.

Here, for the purpose of comparison, some camera modules may be considered. First, it is assumed that a camera module has a rigid substrate having a camera unit mounted thereon and a flexible substrate connected to an upper surface or a lower surface of the rigid substrate. According to this configuration, since the rigid substrate has a predetermined thickness, the whole thickness of the camera module is likely to be greater. In addition, if the rigid substrate is thick, heat removal of the camera unit may not be sufficient.

Then, it is assumed that a camera module includes a rigid substrate having a camera unit mounted thereon and a flexible substrate connected to a lower surface or an upper surface of the rigid substrate, and that recess for partially accommodating the camera unit is disposed in the rigid substrate. According to this configuration, the camera module may be partially thinner, but rigidity of the camera module is degraded or resistance against warping is degraded due to the presence of the recess.

Then, it is assumed that a camera module includes a rigid flexible substrate and a camera unit mounted on the rigid flexible substrate, and that a flexible substrate is partially located in the rigid substrate. According to this configuration, since the rigid flexible substrate has a predetermined thickness, the whole thickness of the camera module is likely to become greater. In addition, if the rigid flexible substrate is thick, heat removal of the camera unit may not be sufficient.

In contrast, the camera module 4 according to the embodiment described herein includes the flexible substrate 11 having the first region 15 and the second region 16, the imaging device 21 disposed in the first region 15, the molded resin body 24 disposed in the first region 15 and covering the peripheral end portion of the imaging device 21, and the terminal 27 disposed on the surface of the second region 16. According to this configuration, the molded resin body 24 disposed in the peripheral end portion of the imaging device 21 reinforces the flexible substrate 11, thereby improving rigidity or resistance against warping for the camera module 4. For this reason, as a substrate having the imaging device 21 mounted thereon, a relatively thin substrate may be employed. Therefore, it is possible to provide the camera module 4 which may become thinner as a whole while maintaining rigidity. In addition, heat generated by the imaging device 21 during the operation is partially diffused from the imaging device 21 into the molded resin body 24, and is removed from a relatively large surface of the molded resin body 24. Therefore, according to the configuration of the embodiment described herein, it is possible to improve heat removal of the camera module 4.

Furthermore, in the embodiment described herein, the logic circuit 36 of the imaging device 21 is covered with the molded resin body 24. The logic circuit 36 is one of the heat generating unit in the imaging device 21. For this reason, if the logic circuit 36 is covered with the molded resin body 24, the heat generated by the logic circuit 36 is partially and efficiently transferred to the molded resin body 24, and is effectively removed through the molded resin body 24. Therefore, according to the above-described configuration, it is possible to further improve heat removal of the camera module 4.

In the embodiment described herein, the camera module 4 has the bonding wire 33 extending between the imaging device 21 and the surface of the first region 15. The molded resin body 24 seals the bonding wire 33. According to this configuration, since the surrounding of the bonding wire 33 is reinforced, it is possible to further improve resistance against warping for the camera module 4.

In the embodiment described herein, the camera module 4 includes the lens unit 25. The lens unit 25 has the lens 51 facing the imaging device 21 and the frame 52 supporting the lens 51 and covering at least a portion of the molded resin body 24. According to this configuration, in the lens unit 25, the molded resin body 24 may be guided and attached thereto by covering the frame 52 with the molded resin body 24. Therefore, according to the above-described configuration, it is possible to easily assemble the camera module 4.

In the embodiment described herein, the flexible substrate 11 includes the electrode 64 disposed on the surface of the flexible substrate 11 outside the lens unit 25. The lens unit 25 includes the wiring unit 65 which is disposed in the exterior portion of the frame 52 and electrically connects the lens 51 and the electrode 64 to each other. According to this configuration, even if the molded resin body 24 is present, it is possible to facilitate work for connecting the wiring unit 65 and the electrode 64 to each other. In addition, according to the above-described configuration, it is no longer necessary to dispose a gap for passing the wiring unit 65 therethrough between the surface of the molded resin body 24 and the inner surface of the frame 52. Therefore, the inner surface shape of the lens unit 25 is likely to be aligned with the outer shape of the molded resin body 24. If the inner surface shape of the lens unit 25 may be aligned with the outer shape of the molded resin body 24, the molded resin body 24 functions more effectively as a guide. Therefore, attachment work for the lens unit 25 may become easier, and attachment accuracy may be also improved.

The wiring unit 65 of the lens unit 25 is disposed outside the frame 52, thereby enabling the frame 52 and the molded resin body 24 to physically contact (for example, to closely adhere to each other). If the frame 52 and the molded resin body 24 physically contact, heat transferred from the imaging device 21 to the molded resin body 24 may be partially and efficiently transferred from the molded resin body 24 to the frame 52. In this manner, the heat may be removed via the frame 52. Therefore, according to the above-described configuration, it is possible to further improve heat removal of the camera module 4.

In the embodiment described herein, the frame 52 includes the concave portion 61 which is recessed inward from the side surface of the frame 52. At least a portion of the electrode 64 is located inside the concave portion 61 of the frame 52. According to this configuration, it is possible to dispose a portion of the electrode 64 in the exterior portion of the frame 52 using a region which would be located within the frame 52. Therefore, the flexible substrate 11 may be mounted thereon very densely, thereby enabling the camera module 4 to be miniaturized.

In the embodiment described herein, the molded resin body 24 has the recess 62 extending along the concave portion 61 of the frame 52. The concave portion 61 of the frame 52 is attached to the recess 62 of the molded resin body 24. According to this configuration, in the frame 52, the concave portion 61 of the frame 52 is disposed along the recess 62 of the molded resin body 24, thereby enabling easy positioning of the frame 52. Therefore, according to the above-described configuration, it is possible to more easily assemble the camera module 4.

In the embodiment described herein, at least a portion of the frame 52 has the conductive shield layer 57 which is electrically connected to the flexible substrate 11. According to this configuration, the shield layer 57 functions as a shield for dealing with EMI. In this manner, it is possible to decrease influence of electromagnetic waves oriented from the outside toward the inside of the frame 52, or electromagnetic waves oriented from the inside toward the outside of the frame 52. This enables the camera module 4 to perform a stable and reliable operation.

### Modification Example

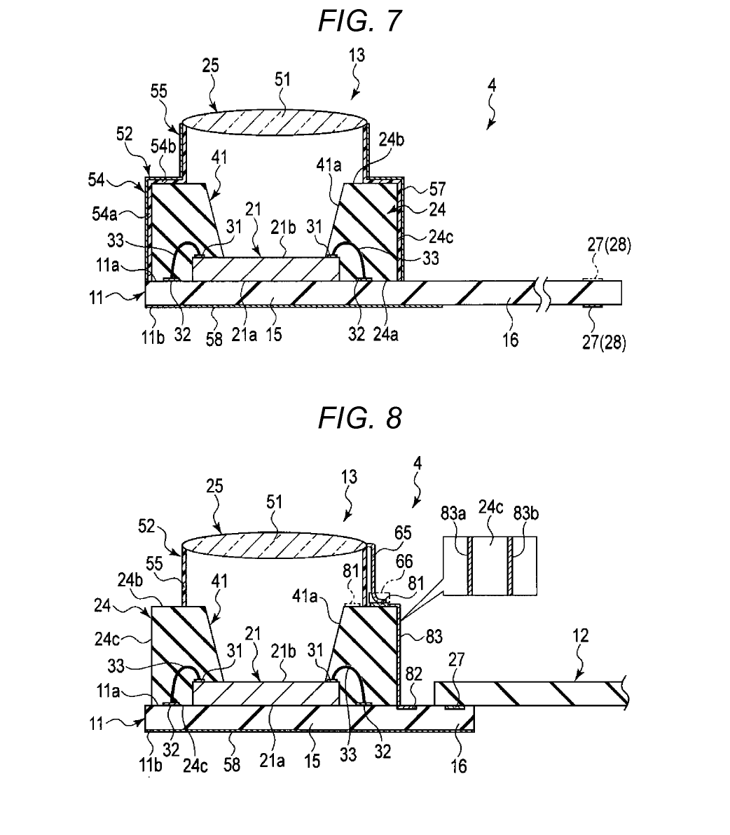

FIG. 7 illustrates one modification example of the camera module 4 according to the first embodiment. In the modification example, the camera module 4 does not have the flexible substrate 12. In the modification example, the flexible substrate 11 is extended, thereby functioning as the flexible substrate 12. In other words, in the modification example, as the flexible substrate 11, the flexible substrate 11 and the flexible substrate 12 according to the first embodiment are formed integrally. The terminal 27 may be disposed on the second surface 11b of the flexible substrate 11, or may be disposed on the first surface 11a of the flexible substrate 11 as illustrated by a two-dot chain line in FIG. 7. For example, the terminal 27 according to the modification example has a function which is substantially similar to that of the interface 28 according to the first embodiment.

Similarly to the above-described first embodiment, according to this configuration, it is also possible to provide the camera module 4 which is thinner while maintaining rigidity.

Next, second and third embodiments will be described. The same reference numerals are given to configuration elements having functions which are the same as or similar to those of the configuration elements in the above-described first embodiment, and description thereof will be omitted. In addition, configuration elements other than those described below are the same as the configuration elements in the first embodiment.

### Second Embodiment

FIG. 8 illustrates the camera module 4 according to the second embodiment. In the embodiment described herein, as an example, the frame 52 of the lens unit 25 does not have the first portion 54, and has only the second portion 55. The lens unit 25 is attached to the upper surface (second surface 24b) of the molded resin body 24. The frame 52 does not cover the side surface 24c of the molded resin body 24. Therefore, without being covered with the frame 52, the side surface 24c of the molded resin body 24 is exposed outward as a surface of the camera module 4.

As illustrated in FIG. 8, the second surface 24b of the molded resin body 24 has multiple first pads 81 (first electrodes). For example, the multiple first pads 81 serve as electrodes for controlling the lens 51 (for example, for controlling a focus function), and include a positive electrode and a negative electrode. The wiring unit 65 of the lens 51 is electrically connected to the first pads 81. A position of the first pads 81 may be in the exterior portion of the frame 52, or may be in the interior portion of the frame 52 as illustrated by a two-dot chain line in FIG. 8.

Alternatively, the wiring unit 65 and the pads 81 may be electrically connected to each other by disposing the connector 66 (socket) connected to the pads 81 on the second surface 24b of the molded resin body 24, and by inserting the end portion of the wiring unit 65 into the connector 66 (refer to a two-dot chain line in FIG. 8).

In contrast, the flexible substrate 11 includes multiple second pads 82 (second electrodes). For example, similarly to the first pads 81, the multiple second pads 82 serve as electrodes for controlling the lens 51 (for example, for controlling a focus function), and include a positive electrode and a negative electrode. For example, the second pads 82 are disposed in a boundary between the side surface 24c of the molded resin body 24 and the flexible substrate 11.

A conductive pattern 83 (wiring pattern) is disposed on the side surface 24c of the molded resin body 24. The conductive pattern 83 extends in the thickness direction of the flexible substrate 11. One end portion of the conductive pattern 83 extends from the side surface 24c to the second surface 24b of the molded resin body 24, and is connected to the first pads 81 on the second surface 24b. That is, the conductive pattern 83 is electrically connected to the lens unit 25 on the second surface 24b of the molded resin body 24. If the first pads 81 are disposed in the boundary between the side surface 24c and the second surface 24b of the molded resin body 24, the conductive pattern 83 does not need to extend up to the second surface 24b, and may be disposed only on the side surface 24c.

The other end portion of the conductive pattern 83 extends up to the boundary between the side surface 24c of the molded resin body 24 and the flexible substrate 11, and is connected to the second pads 82 at the boundary between the side surface 24c of the molded resin body 24 and the flexible substrate 11. That is, the conductive pattern 83 is electrically connected to the flexible substrate 11 at the boundary between the molded resin body 24 and the flexible substrate 11.

In this manner, the conductive pattern 83 electrically connects the lens unit 25 and the flexible substrate 11 to each other. The conductive pattern 83 includes at least a first line 83a which connects the positive electrode of the first pads 81 and the negative electrode of the second pads 82, and a second line 83b which connects the negative electrode of the first pads 81 and the positive electrode of the second pads 82. The conductive pattern 83 is formed on the surface of the molded resin body 24 by plating or sputtering. A forming method of the conductive pattern 83 is not limited thereto. In addition, the shield layer 57 similar to that in the first embodiment may be disposed on the surface of the molded resin body 24 excluding a region having the conductive pattern 83.

According to this configuration, similarly to the above-described first embodiment, it is possible to provide the camera module 4 which is thinner while maintaining rigidity.

Furthermore, in the embodiment described herein, the molded resin body 24 has the first surface 24a facing the flexible substrate 11, the second surface 24b located on the side opposite to the first surface 24a, and the side surface 24c extending between the first surface 24a and the second surface 24b. The frame 52 is attached to the second surface 24b of the molded resin body 24. The side surface 24c of the molded resin body 24 is exposed outward as a surface of the camera module 4.

According to this configuration, since the side surface 24c of the molded resin body 24 is exposed, heat transferred from the imaging device 21 to the molded resin body 24 is likely to be effectively transferred outward from the side surface 24c of the molded resin body 24. Therefore, according to the above-described configuration, it is possible to further improve heat removal of the camera module 4.

In the embodiment described herein, the camera module 4 is disposed on at least the side surface 24c of the molded resin body 24, and further includes the conductive pattern 83 which is electrically connected to the lens unit 25. According to this configuration, it is possible to dispose an electrical connection structure of the lens unit 25 while the side surface 24c of the molded resin body 24 is exposed outward.

In the embodiment described herein, the conductive pattern 83 extends up to the boundary between the molded resin body 24 and the flexible substrate 11, and is electrically connected to the flexible substrate 11. According to this configuration, the lens unit 25 and the flexible substrate 11 may be easily electrically connected to each other by connecting the wiring unit 65 of the lens unit 25 to the first pads 81.

### Third Embodiment

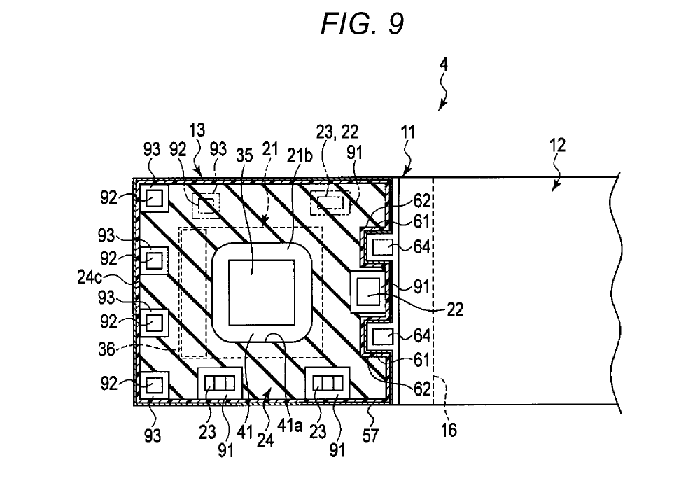

FIG. 9 illustrates the camera module 4 according to the third embodiment. In the embodiment described herein, the molded resin body 24 has a non-sealed portion 91 (open portion) having no molded resin body 24 at a position corresponding to the controller 22 and the electronic component 23. For example, the non-sealed portion 91 is a cut-out portion or a hole, which is formed in the molded resin body 24. Therefore, the controller 22 and the electronic component 23 are not covered with the molded resin body 24, and are exposed outward as a surface of the camera module 4 (accessible from the outside) in a state where at least the lens unit 25 is detached therefrom. The non-sealed portion 91 having the hole is illustrated by a two-dot chain line in FIG. 9.

In the embodiment described herein, the first region 15 of the flexible substrate 11 further has multiple test pads 92, for example. For example, the test pad 92 is at least any one test terminal for one of the imaging device 21, the controller 22, and the electronic component 23, which are mounted on the flexible substrate 11. That is, a test current or a test signal is caused to flow into the test pad 92, and thus it is possible to check the operation of the imaging device 21, the controller 22, or the electronic component 23.

In the embodiment described herein, the molded resin body 24 has a non-sealed portion 93 (open portion) having no molded resin body 24 at the position corresponding to the test pad 92. For example, the non-sealed portion 93 is a cut-out portion or a hole which is formed in the molded resin body 24. Therefore, the test pad 92 is not covered with the molded resin body 24, and is exposed outward on the camera module 4 (accessible from the outside) in a state where at least the lens unit 25 is detached therefrom. The non-sealed portion 93 having the hole is illustrated by a two-dot chain line in FIG. 9.

According to this configuration, similarly to the above-described first embodiment, it is possible to provide the camera module 4 which is thinner while maintaining rigidity.

Furthermore, in the embodiment described herein, the molded resin body 24 includes the non-sealed portion 91 at the position corresponding to the electronic component 23 so that the electronic component 23 is exposed outward in a state where at least the lens unit 25 is detached therefrom. According to this configuration, when the controller 22 and the electronic component 23 are defective, it is possible to easily carry out repair work for the controller 22 and the electronic component 23. In this manner, it is possible to improve production yield, and it is possible to further improve reliability of the camera module 4.

In the embodiment described herein, the flexible substrate 11 further includes the test pad 92 disposed in the first region 15. The molded resin body 24 includes the non-sealed portion 93 at the position corresponding to the test pad 92 so that the test pad 92 is exposed outward in a state where at least the lens unit 25 is detached therefrom. According to this configuration, in a state where the molded resin body 24 is disposed, it is possible to check at least any one operation of the imaging device 21, the controller 22, and the electronic component 23 using the test pad 92. In this manner, a product test of the camera module 4 can be carried out, and it is possible to further improve reliability of the camera module 4.

The test pad 92 may be disposed within the frame 52, or outside the frame 52. If the test pad 92 is disposed within the frame 52, the test pad 92 is exposed outward on the camera module 4 even if the frame 52 is not detached from the camera module 4.

As above, the first to third embodiments are described, but the embodiment is not limited to the above-described examples. For example, the above-described respective embodiments may be achieved in combination with each other.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device module, comprising:
a substrate;
an imaging unit disposed on the substrate and electrically connected thereto;
a resin member disposed on the substrate and covering a peripheral region of the imaging unit;
a lens unit disposed above the imaging unit; and
a frame having a portion that is disposed on the resin member and supports the lens unit.

2. The electronic device module according to claim 1, wherein
the imaging unit is electrically connected to the substrate through a bonding wire, and
the resin member covers the wiring.

3. The electronic device module according to claim 1, wherein
the imaging unit includes an array of light receiving elements facing the lens unit and a logic circuit disposed in the peripheral region, and
the resin member covers the logic circuit and does not cover the array of light receiving elements.

4. The electronic device module according to claim 1, wherein
the substrate includes an electrode pad, and
the lens unit is electrically connected to the electrode pad through a wiring.

5. The electronic device module according to claim 4, wherein
at least a portion of the wiring is formed on a side surface of the resin member.

6. The electronic device module according to claim 4, wherein
the resin member does not cover the electrode pad, and
at least a portion of the electrode pad is exposed.

7. The electronic device module according to claim 6, wherein
the resin member has a recessed portion on a side surface thereof, and
the portion of the electrode pad is exposed through the recessed portion of the resin member.

8. The electronic device module according to claim 1, wherein
the frame has a portion covering a top surface and side surfaces of the resin member.

9. The electronic device module according to claim 8, wherein
the frame includes a conductive layer that is formed on an outer surface of the portion and electrically connected to the substrate.

10. The electronic device module according to claim 1, wherein
the frame includes a conductive layer that is formed on an outer surface thereof and electrically connected to the substrate.

11. The electronic device module according to claim 1, wherein
the frame lies on the top surface of the resin member and does not cover a side surface of the resin member.

12. The electronic device module according to claim 1, further comprising:
an electronic unit disposed on the substrate, wherein
the resin member does not cover the electronic unit.

13. The electronic device module according to claim 12, wherein
the electronic unit is a controller configured to control the imaging unit.

14. The electronic device module according to claim 1, wherein
the substrate includes a test electrode pad disposed thereon and electrically connected to the imaging unit, and
the resin member does not cover the test electrode pad.

15. The electronic device module according to claim 1, wherein the substrate is a flexible film.

16. An electronic device module, comprising:
a substrate having an electrode pad for electrical connection with an external device;
an imaging unit disposed on the substrate and electrically connected thereto; and
a resin member disposed on the substrate and covering an peripheral region of the imaging unit, the electrode pad being not covered by the resin member.

17. The electronic device module according to claim 16, wherein
the imaging unit is electrically connected to the substrate through a wiring, and
the resin member covers the wiring.

18. The electronic device module according to claim 16, wherein
the imaging unit includes an array of light receiving elements and a logic circuit disposed in the peripheral region, and
the resin member covers the logic circuit and does not cover the array of light receiving elements.

19. The electronic device module according to claim 16, further comprising:
a lens unit disposed above the imaging unit; and
a frame having a portion that is disposed on a top surface of the resin member and supports the lens unit.

20. The electronic device module according to claim 19, wherein
the frame has a portion covering a top surface and side surfaces of the resin member.
